(19) United States
(12) Patent Application Publication
(10) Pub. No.: US 2026/0104103 A1
(43) Pub. Date: Apr. 16, 2026

(54) THROTTLE DEVICE

(71) Applicant: AISAN KOGYO KABUSHIKI KAISHA, Obu-shi (JP)

(72) Inventors: Yuichi KIMURA, Kariya-shi (JP); Akihito KUNO, Tokai-shi (JP)

(73) Assignee: AISAN KOGYO KABUSHIKI KAISHA, Obu-shi (JP)

(21) Appl. No.: 19/323,556

(22) Filed: Sep. 9, 2025

(30) Foreign Application Priority Data
Oct. 14, 2024 (JP) 2024-179510

(51) Int. Cl. F16K 31/04; F16K 27/02

(52) U.S. Cl. CPC F16K 31/041; F16K 27/0218

(57) ABSTRACT

A throttle device includes a valve element, a valve shaft with the valve element fixed thereto, a motor for rotating the valve shaft, a housing in which the motor is accommodated, and a cavity for mounting the motor in the housing. The cavity includes a large-diameter accommodation section and a small-diameter accommodation section, which are arranged coaxially. The minimum thickness between the inner peripheral surface of the large-diameter accommodation section and the outer peripheral surface of the housing is equal to or thinner than the minimum thickness between the inner peripheral surface of the small-diameter accommodation section and the outer peripheral surface of the housing.

### CROSS-REFERENCE TO RELATED APPLICATIONS

This application is based upon and claims the benefit of priority to Japanese Patent Application No. 2024-179510 filed on Oct. 14, 2024, the entire contents of which are incorporated herein by reference.

### BACKGROUND

### Technical Field

The disclosure relates to a throttle device that internally contains a motor, and is driven by the motor.

### Related Art

Conventionally, as an example of the above type of technique, a throttle device described in Japanese unexamined patent application publication No. 2013-104392 (JP 2013-104392A) is known. This device is provided with a valve shaft with a valve element fixed in place, an electrically-driven motor that rotates the valve shaft, a housing that accommodates the motor, and a cover that covers the motor accommodated in the housing. The housing includes a cavity in which the motor is mounted. The motor mounted in the cavity is fixed to the housing via a bracket. The motor has a motor terminal. The cover has a cover terminal. The bracket has an intermediate terminal that connects the motor terminal and the cover terminal. Herein, in some cases, the motor of the throttle device needs to be replaced with a different motor (e.g., a motor having a different size). In this case, even if the position of the motor terminal of the different motor is different from that of the motor terminal of the existing motor, the motor terminal can be connected to the cover terminal via the intermediate terminal. Thus, the different motor can be mounted and used in the throttle device.

### SUMMARY

### Technical Problems

However, in the throttle device described in JP 2013-104392A, when the size of the different motor to be mounted in place of the existing motor is larger than the size of the existing motor, it is difficult to accommodate the different motor in the cavity, and the different motor cannot be used. Alternatively, it is necessary to additionally provide a new housing.

The disclosure has been made to address the above problems and has a purpose to provide a throttle device enabling a different motor having a larger outer diameter than that of an existing motor to be accommodated and used in a housing, without adding a new housing.

### Means of Solving the Problems

To achieve the above-mentioned purpose, one aspect of the present disclosure provides a throttle device comprising: a valve element; a valve shaft to which the valve element is fixed; a motor that is electrically driven to rotate the valve shaft; a housing in which the motor is accommodated; and a cavity for mounting the motor in the housing, wherein the cavity includes a large-diameter accommodation section and a small-diameter accommodation section, which are arranged coaxially, and a minimum thickness between an inner peripheral surface of the large-diameter accommodation section and an outer peripheral surface of the housing is equal to or thinner than a minimum thickness between an inner peripheral surface of the small-diameter accommodation section and the outer peripheral surface of the housing.

According to this configuration, the motor can be mounted in the cavity. In this cavity, the minimum thickness between the inner peripheral surface of the large-diameter accommodation section and the outer peripheral surface of the housing is equal to or thinner than the minimum thickness between the inner peripheral surface of the small-diameter accommodation section and the outer peripheral surface of the housing. Therefore, for a throttle device just after manufacture, the outer diameter of the motor to be mounted in the cavity is determined by the inner diameter of the small-diameter accommodation section. When replacing the motor of the throttle device with another motor having a larger outer diameter, the inner peripheral wall of the small-diameter accommodation section is cut away to increase the inner diameter of the small-diameter accommodation section to the same diameter as the inner diameter of the large-diameter accommodation section. Thus, the housing can accommodate the different motor with the larger diameter than that of the existing motor without needing to add a new housing.

In the above-described configuration, the housing includes a stepped section between the inner peripheral surface of the large-diameter accommodation section and the inner peripheral surface of the small-diameter accommodation section, and the stepped section has a surface having an R-shape or a taper shape.

According to the above-described configuration, the stepped section is provided between the inner peripheral surface of the large-diameter accommodation section and the inner peripheral surface of the small-diameter accommodation section, enabling the inner wall of the small-diameter accommodation section to be cut away, using the width of the stepped section as a reference or guideline. Further, since the surface of the stepped section in cross-section is R-shaped, i.e., round, or tapered, the motor is less likely to catch on the stepped section when the motor is mounted into the cavity. Thus, the stepped section can easily provide a cutting allowance of the small-diameter accommodation section. The surface shape, i.e., surface profile, of the stepped section can enhance the mountability of the motor into the cavity.

### BRIEF DESCRIPTION OF THE DRAWINGS

FIG. 1 is a perspective view showing the outer appearance of a throttle device in an embodiment.

FIG. 2 is a cross-sectional view showing a motor accommodating part in the embodiment, which is enclosed by a chain line in FIG. 1.

FIG. 3 is a cross-sectional view of the motor accommodating part in the embodiment, in a state where a motor, a gear mechanism, and a cover are removed from FIG. 2.

FIG. 4 is a cross-sectional view, similar to FIG. 3, showing a state where an inner peripheral wall of a small-diameter accommodation section is partly cut away.

### DETAILED DESCRIPTION OF THE EXEMPLARY EMBODIMENTS

A detailed description of an embodiment of a throttle device will now be given referring to the accompanying drawings.

### Schematic Configuration of Throttle Device

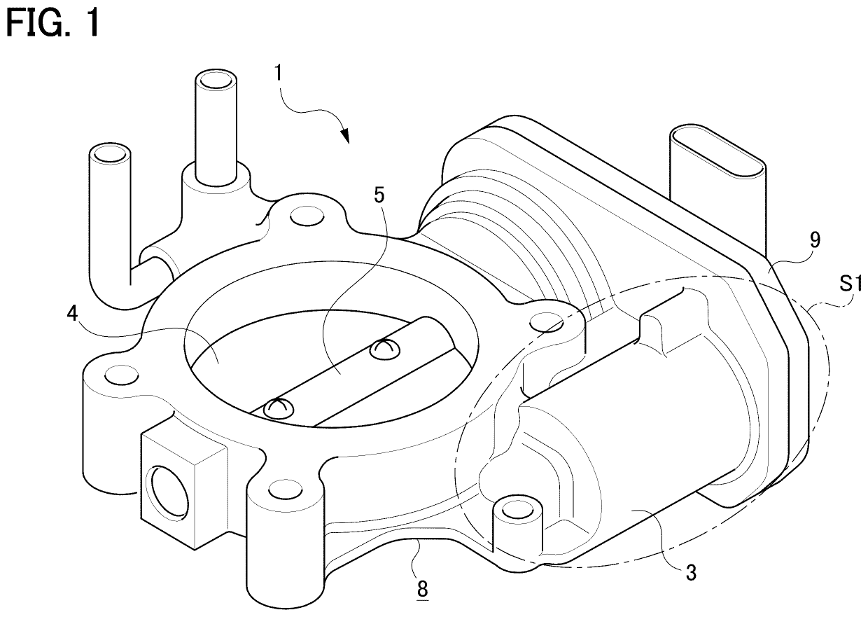

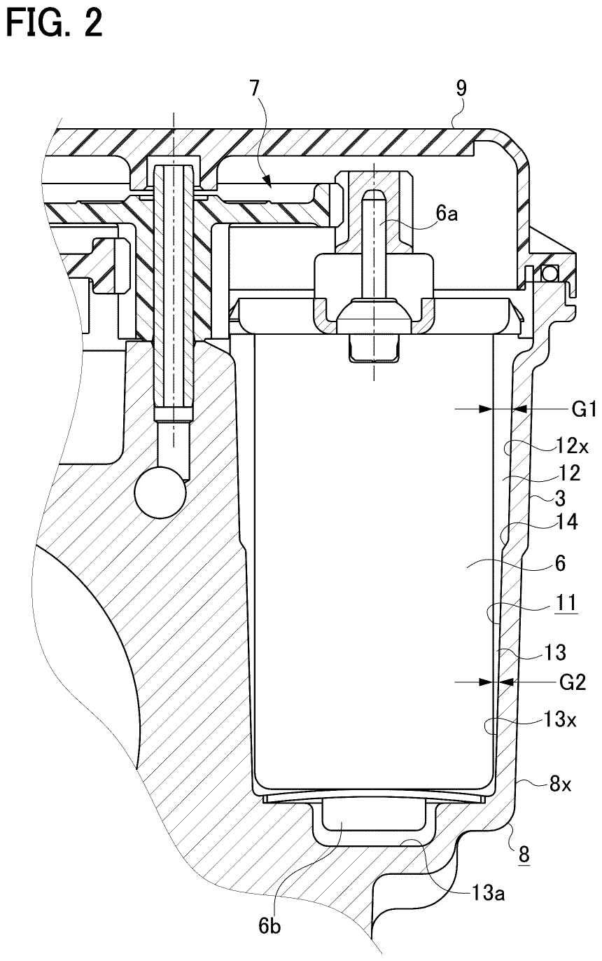

FIG. 1 is a perspective view of the outer appearance of a throttle device 1. FIG. 2 is a cross-sectional view of a motor accommodating part 3, enclosed by a chain line in FIG. 1. This throttle device 1 in the embodiment will be placed in an air intake passage of a vehicle engine and used to regulate the volume of air to be supplied to the engine.

As shown in FIG. 1 and FIG. 2, the throttle device 1 includes a butterfly valve element 4, a valve shaft 5 to which the valve element 4 is fixed, a motor 6 that is electrically driven to rotate the valve shaft 5, a gear mechanism 7 that drivingly couples the motor 6 to the valve shaft 5, a housing 8 in which the motor 6 and the gear mechanism 7 are accommodated, and a cover 9 that covers the motor 6 and gear mechanism 7 accommodated in the housing 8. The housing 8 is made of aluminum or the like by die-casting. The cover 9 is made of resin by molding. As shown in FIG. 1, the housing 8 includes a motor accommodating part 3 of a cylindrical shape as can be seen from its appearance.

As shown in FIG. 2, the motor accommodating part 3 of the housing 8 is provided with a bottomed cavity 11 for mounting the motor 6 therein. The cavity 11 includes a large-diameter accommodation section 12 and a small-diameter accommodation section 13, which are arranged coaxially. The large-diameter accommodation section 12 is located on the opening side of the cavity 11 and the small-diameter accommodation section 13 is located on the bottom side of the cavity 11. An output shaft 6a of the motor 6 is placed on the opening side of the cavity 11. The small-diameter accommodation section 13 includes, in its bottom, a recess 13a. The motor 6 includes a protruding part 6b on the opposite side to the output shaft 6a. In the recess 13a, the protruding part 6b of the motor 6 is inserted. Between the inner peripheral surface of the cavity 11 and the outer peripheral surface of the motor 6, predetermined gaps G1 and G2 are provided. In other words, the outer peripheral surface of the motor 6 does not contact with the inner peripheral surface of the cavity 11. The gap G1 is a clearance provided in the large-diameter accommodation section 12 and the gap G2 is a clearance provided in the small-diameter accommodation section 13. These gaps G1 and G2 are provided to ensure heat insulation and impact resistance of the motor 6.

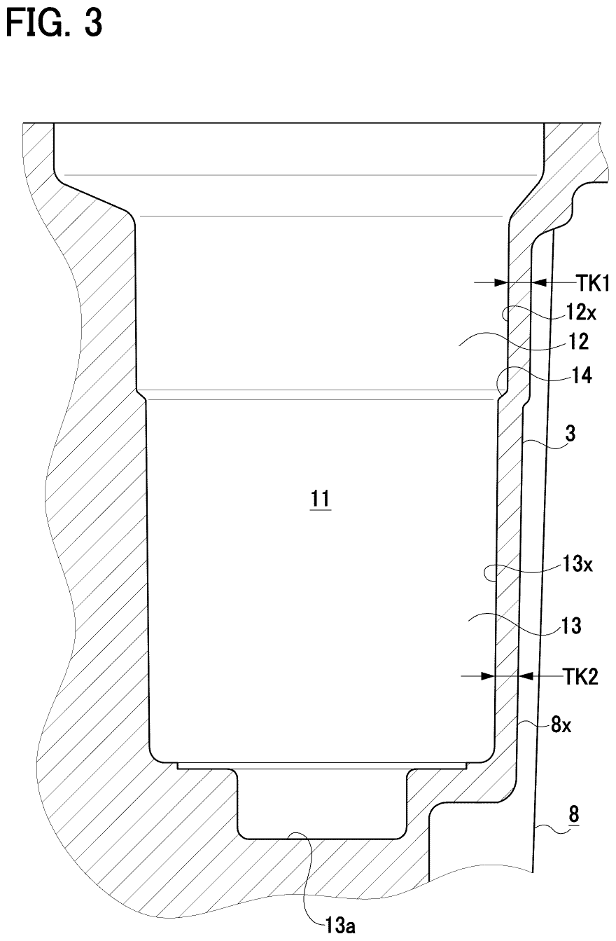

FIG. 3 is a cross-sectional view showing the motor accommodating part 3 in a state where the motor 6, the gear mechanism 7, and the cover 9 are removed from FIG. 2. As shown in FIGS. 2 and 3, the minimum thickness TK1 of the housing 8, i.e., the motor accommodating part 3, between an inner peripheral surface 12x of the large-diameter accommodation section 12 and an outer peripheral surface 8x of the housing 8 is equal to or thinner than the minimum thickness TK2 of the housing 8, i.e., the motor accommodating part 3, between an inner peripheral surface 13x of the small-diameter accommodation section 13 and the outer peripheral surface 8x of the housing 8.

A stepped section 14 is provided between the inner peripheral surface 12x of the large-diameter accommodation section 12 and the inner peripheral surface 13x of the small-diameter accommodation section 13. The stepped section 14 has a surface having an R shape, i.e., a rounded shape, or a taper shape. The cavity 11 is divided into the large-diameter accommodation section 12 and the small-diameter accommodation section 13 by the stepped section 14 serving as the boundary. This configuration that the large-diameter accommodation section 12 and the small-diameter accommodation section 13 are provided separately on both sides of the stepped section 14 is intended to enable another motor having a different outer diameter to be mounted in the cavity 11.

### Operations and Effects of Throttle Device

According to the throttle device 1 configured as above in the embodiment, the motor 6 is mounted in the cavity 11 of the housing 8. Here, in the cavity 11, the minimum thickness TK1 between the inner peripheral surface 12x of the large-diameter accommodation section 12 and the outer peripheral surface 8x of the housing 8 is equal to or thinner than the minimum thickness TK2 between the inner peripheral surface 13x of the small-diameter accommodation section 13 and the outer peripheral surface 8x of the housing 8. Therefore, for the throttle device 1 just after manufacture, the outer diameter of the motor 6 to be mounted in the cavity 11 is determined by the inner diameter of the small-diameter accommodation section 13.

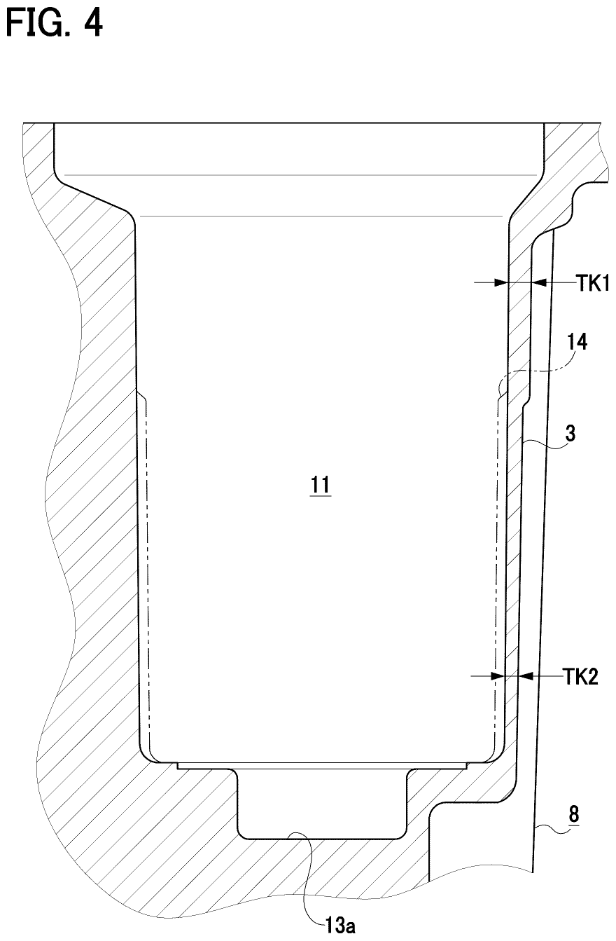

Here, FIG. 4 is a cross-sectional view, similar to FIG. 3, showing a state where the inner peripheral wall of the small-diameter accommodation section 13 is partly cut away. To replace the motor 6 with another motor having a larger outer diameter than the motor 6, the inner peripheral wall of the small-diameter accommodation section 13 is cut away, or machined, to increase the inner diameter of the small-diameter accommodation section 13 to reach the inner diameter of the large-diameter accommodation section 12, as shown in FIG. 4. This configuration enables another motor having a larger outer diameter than the existing motor 6 to be accommodated and used in the housing 8, without providing an additional housing 8.

According to the configuration in the above embodiment, the stepped section 14 is provided between the inner peripheral surface 12x of the large-diameter accommodation section 12 and the inner peripheral surface 13x of the small-diameter accommodation section 13. This enables the inner wall of the small-diameter accommodation section 13 to be cut away, using the width of the stepped section 14 as a reference or guideline, as shown in FIG. 4. Thus, the stepped section 14 can easily ensure a cutting allowance of the small-diameter accommodation section 13. Furthermore, the surface of the stepped section 14 has a R-shape or a taper shape, which can reduce the possibility that the motor 6 catches on the stepped section 14 when the motor 6 is mounted into the cavity 11. Therefore, the surface profile of the stepped section 14 can enhance the mountability of the motor 6 into the cavity 11.

The disclosure is not limited to the above-described embodiment and may be embodied in other specific forms without departing from the essential characteristics thereof.

For example, the surface of the stepped section 14 in the foregoing embodiment is R-shaped or tapered, but may be flat.

The disclosure is applicable to a throttle device provided in an air intake passage of an engine.

### REFERENCE SIGNS LIST

1 Throttle device
4 Valve element
5 Valve shaft
6 Motor
8 Housing
11 Cavity
12 Large-diameter accommodation section
13 Small-diameter accommodation section
14 Stepped section

What is claimed is:

1. A throttle device comprising:
a valve element;
a valve shaft to which the valve element is fixed;
a motor that is electrically driven to rotate the valve shaft;
a housing in which the motor is accommodated; and
a cavity for mounting the motor in the housing,
wherein the cavity includes a large-diameter accommodation section and a small-diameter accommodation section, which are arranged coaxially, and
a minimum thickness between an inner peripheral surface of the large-diameter accommodation section and an outer peripheral surface of the housing is equal to or thinner than a minimum thickness between an inner peripheral surface of the small-diameter accommodation section and the outer peripheral surface of the housing.

2. The throttle device according to claim 1, wherein
the housing includes a stepped section between the inner peripheral surface of the large-diameter accommodation section and the inner peripheral surface of the small-diameter accommodation section, and
the stepped section has a surface having an R-shape or a taper shape.
